(19) United States
(12) Patent Application Publication
(10) Pub. No.: US 2021/0101596 A1
(43) Pub. Date: Apr. 8, 2021

(54) SYSTEM AND METHOD FOR A VEHICLE ADAPTIVE CRUISE CONTROL FOR A STOP-GO EVENT

(71) Applicant: DENSO International America, Inc., Southfield, MI (US)

(72) Inventors: Yu YAN, Novi, MI (US); Hiroshi INOU, West Bloomfield, MI (US); Brandon BURNETT, White Lake, MI (US); Minglei HUANG, Novi, MI (US)

(73) Assignee: DENSO International America, Inc., Southfield, MI (US)

(21) Appl. No.: 16/592,693

(22) Filed: Oct. 3, 2019

(51) Int. Cl. B60W 30/17; G06K 9/00; B60W 40/107

(52) U.S. Cl. CPC B60W 30/17; G06K 9/00825; B60W 2720/106; B60W 2550/30; B60W 40/107

(57) ABSTRACT

A vehicle control system includes a controller that is to be provided in a subject vehicle. The controller is configured to acquire data regarding an identified object ahead of the subject vehicle, determine whether the identified object is a stop-go object based on the acquired data, and output a stop-go control in response to the identified object being the stop-go object. The data includes information indicative of a classification of the identified object, and the stop-go control generates a dynamic profile that defines a deceleration and an acceleration of the subject vehicle for automatically performing a stop-go operation.

### FIELD

The present disclosure relates to a system and a method for a vehicle adaptive cruise control.

### BACKGROUND

The statements in this section merely provide background information related to the present disclosure and may not constitute prior art.

Typically, a vehicle is equipped with a cruise control application that maintains a speed of the vehicle to a desired speed set by a driver until the driver disengages the cruise control by, for example, operating a brake pedal. Technological developments in vehicular automation have led way to a more autonomous form of cruise control typically referred to as adaptive cruise control or even semi-autonomous cruise control in which the speed of the vehicle is automatically adjusted to maintain a safe distance from a front vehicle. Specifically, while the speed of the vehicle is initially maintained to the desired speed, the adaptive cruise control may automatically reduce the speed in order to control the distance between the vehicle and the front vehicle. Such adaptative cruise control is typically activated along roads that do not have frequent stop and go travel of the vehicle such as a highway or a road with minimal intersections having stop signs and/or traffic lights. That is, most adaptive cruise controls are not activated in urban areas due to the stop and go driving conditions typically provided in an urban areas.

### SUMMARY

This section provides a general summary of the disclosure and is not a comprehensive disclosure of its full scope or all of its features.

In one form, the present disclosure provides a vehicle control system comprising a controller to be provided in a subject vehicle. The controller is configured to acquire data regarding an identified object ahead of the subject vehicle, where the data includes information indicative of a classification of the identified object. The controller is further configured to determine whether the identified object is a stop-go object based on the acquired data and output a stop-go control in response to the identified object being the stop-go object. The stop-go control generates a dynamic profile that defines a deceleration and an acceleration of the subject vehicle for automatically performing a stop-go operation.

In another form, the present disclosure provides a vehicle control system comprising a controller to be provided in a subject vehicle. The controller is configured to acquire data regarding an identified object ahead of the subject vehicle, where the data includes information indicative of a classification of the identified object. In this form, the controller is further configured to determine whether the identified object is a stop-go object or a front vehicle object based on the acquired data, and perform a stop-go control in response to the identified object being the stop-go object and a front vehicle control in response to the identified object being the front vehicle. The stop-go control generates a dynamic profile that define a deceleration and an acceleration of the subject vehicle for automatically performing a stop-go operation. The front vehicle control determines a recommended speed for the subject vehicle based on a drive characteristic of the front vehicle.

In yet another form, the present disclosure further provides a method for performing an adaptive cruise control. The method comprises: acquiring data regarding an identified object ahead of a subject vehicle, where the data includes information indicative of a classification of the identified object; determining whether the identified object is a stop-go object or a front vehicle based on the acquired data; performing a stop-go control in response to the identified object being the stop-go object; performing a front vehicle control in response to the identified object being the front vehicle; and maintaining a speed of the subject vehicle at a desired speed in response to the identified object not being the stop-go object or the front vehicle, where the desired speed is selectable. The stop-go control generates a dynamic profile that defines a deceleration and an acceleration of the subject vehicle for automatically performing a stop-go operation. The front control determines a recommended speed for the subject vehicle based on a drive characteristic of the front vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an urban area with a subject vehicle having an adaptative cruise control application of the present disclosure;

FIG. 2 is an exemplary block diagram of the subject vehicle of FIG. 1;

FIG. 3 is an exemplary block diagram of an object detection module of FIG. 2;

FIG. 4 is an exemplary block diagram of an automation control application stack in accordance with the present disclosure;

FIG. 5 is an exemplary block diagram of the adaptive cruise control application;

FIG. 6 illustrates an exemplary dynamic profile for decelerating and accelerating the subject vehicle;

FIG. 7 is a flow chart of an object detection routine in accordance with the present disclosure; and

FIG. 8 is a flow chart of an adaptive cruise control routine in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

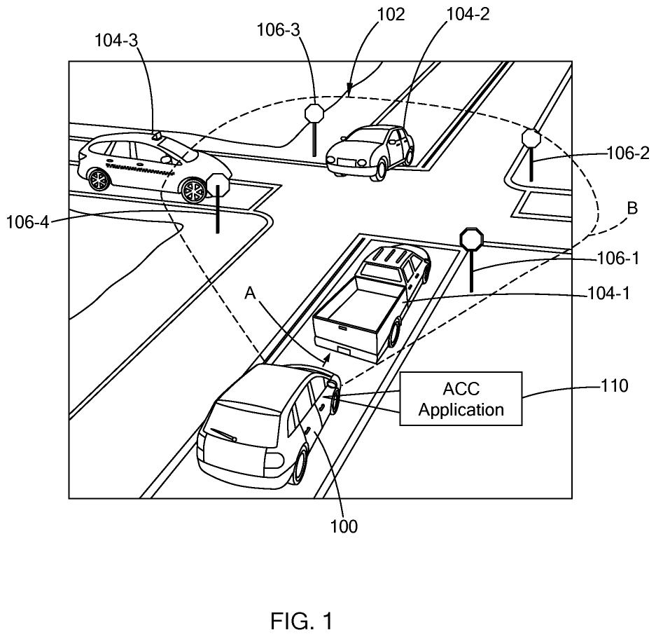

Referring to FIG. 1, in an exemplary application, a subject vehicle 100 is traveling in an urban area having a traffic controlled intersection 102 for managing traffic through an intersection. In this example, along with the subject vehicle 100, other vehicles 104-1, 104-2, and 104-3 (“other vehicles 104” collectively) are also traveling through the traffic controlled intersection 102. Here, the traffic controlled intersection 102 is a four-way stop having four stop signs 106-1 to 106-4 that require vehicles approaching the intersection 102 to stop before proceeding through. A traffic controlled intersection 102 may include other traffic control devices such as traffic signals, yield signs, and/or other suitable device/signage, for controlling the traffic through the intersection.

In such urban area, it is common for a vehicle (e.g., subject vehicle 100 or the other vehicles 104) to experience stop and go travel due to traffic controlled intersections, a moving object (e.g., pedestrian, cyclist, etc.) and other events. To navigate through a stop and go event (i.e., stop-go event), the subject vehicle 100 includes an adaptive cruise control (ACC) application 110 of the present disclosure that controls the deceleration and acceleration of the vehicle 100 to have the vehicle automatically travel through the stop-go event. As described in further detail herein, the ACC application 110 is also configured to control the speed of the subject vehicle 100 based on the speed of a front vehicle traveling ahead of the subject vehicle 100. This is particularly desired when the subject vehicle 100 is traveling along a road with minimal stop-go events such as a highway and/or a road with minimal traffic controlled intersections.

In one form, the subject vehicle 100 is provided as a fully-autonomous vehicle in which a user may enter a destination and a vehicle control system within the subject vehicle 100 drives the subject vehicle 100 to the destination based on a defined travel route. In another form, the subject vehicle 100 is a semi-autonomous that has some level of automation such as, but not limited to collision avoidance, lane control, lane change assist, and/or self-parking. The subject vehicle 100 may also be configured to communicate with other vehicles, roadside devices, and/or other devices such as communication devices provided a business, as part of a vehicle-to-everything (V2X) communication network.

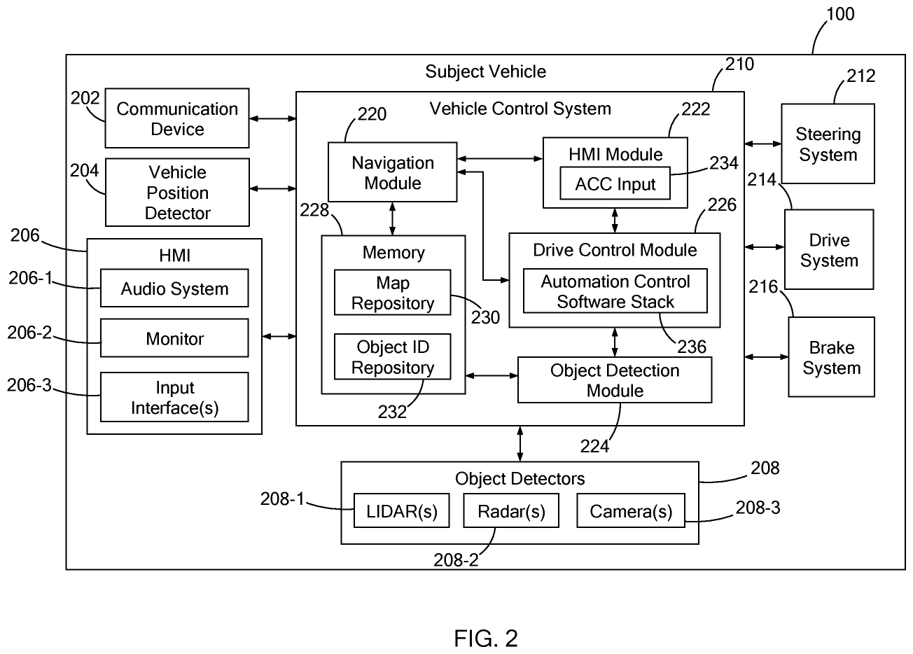

Referring to FIG. 2, an exemplary block diagram of the subject vehicle 100 is provided. In one form, the subject vehicle 100 includes a communication device 202, a vehicle position detector 204, a human machine interface (HMI) 206, one or more object detectors 208 arranged about the subject vehicle 100, and a vehicle control system 210. The devices and systems within the vehicle 100 may communicate with each other by way of a vehicular communication network (not shown) such as, but not limited to, a controller area network (i.e., CAN bus) or local interconnect network (LIN).

The communication device 202 is configured to establish wireless communication with external devices/systems as part of the V2X communication network (e.g., vehicle-to-vehicle, vehicle-to-infrastructure, and/or vehicle-to-node). In one form, the communication device 202 includes a transceiver and a computing device having a microprocessor and a memory for storing computer programs executable by the microprocessor to have the communication device 202 perform the operations described herein. The communication device 202 is configured to process messages received and forward the received message to a component within the subject vehicle 100 by way of the vehicle communication network. The communication device 202 also receives data transmission requests from other components within the subject vehicle 100 to generate and transmit messages to an external device. For example, the communication device 202 may receive a basic safety message from a surrounding vehicle and transmit a basic safety message for the subject vehicle 100. The basic safety message may include a position, a travel direction, and/or a speed of the subject vehicle 100.

The vehicle position detector 204 is configured to determine the location of the subject vehicle 100 and may include a global positioning system (GPS) antenna. In one form, the vehicle control system 210 uses the location to retrieve a map of an area that subject vehicle 100 is traveling in to determine presence of traffic controlled intersections and/or determine travel routes to a selected destination.

The HMI 206 is configured to provide information and/or entertainment to a passenger, and/or receive commands from the passenger. The HMI 206 is typically provided within a passenger cabin of the subject vehicle 100, and may include an audio system 206-1, a monitor 206-2, and/or input interfaces 206-3 such as a touchscreen, buttons, and/or knobs (not shown). In one form, one or more of the HMI 206 is operable by the passenger to input a drive setting, such as, desired speed, activation/deactivation of ACC, and/or other suitable drive settings.

The object detectors 208 are arranged about the subject vehicle 100 and are configured to detect objects about the vehicle 100, which include stationary and moving objects. For example, the object detectors 208 are operable to detect other vehicles, traffic signals, lane markings, traffic signs, pedestrians, vegetation, and road barriers, among others. In one form, at least one object detector is positioned at a front portion of the subject vehicle 100 (e.g., grill, front bumper, rear view mirror, top of a dashboard, etc.) to detect objects in front of the subject vehicle 100. In one form, the object detectors 208 may include a LIDAR(s) 208-1, a radar(s) 208-2, a camera(s) 208-3, and/or a combination thereof. It should be readily understood that other suitable object detectors may also be used and should not be limited to the examples provided herein.

The vehicle control system 210 encompasses one or more controllers that are configured to control different subsystems within the subject vehicle 100 such as, but not limited to, a steering system 212, a drive system 214, and a brake system 216. In the following, the term vehicle subsystems generally refers to subsystems that control movement of the subject vehicle such as the steering system 212, a drive system 214, and a brake system 216.

The steering system 212 includes a series of components such as a steering wheel, steering angle sensors, and powered steering gears, for moving the subject vehicle 100 based on a rotation of the steering wheel provided by a driver. The drive system 214 is configured to generate and deliver power to the wheels of the subject vehicle 100 to move the subject vehicle 100. Based on the type of subject vehicle 100, the drive system 312 includes components such as, but not limited to, engine, transmission, battery system, electric motors, wheels, suspension, converter/generator, actuators, and/or sensors for detecting speed/velocity, wheel angle, and vehicle heading. The brake system 216 is operable to slow the subject vehicle 100 based on a control command from the vehicle control system 210 and/or an input from the driver. Based on the type of brake system (e.g., regenerative, hydraulic, etc.), the brake system 216 may include components such as, but not limited to pedal, brakes, disc, and/or brake controllers. While specific subsystems are illustrated, the vehicle 100 may include other sub-systems such as a climate control system that includes heat exchangers, a compressor, air-ducts, fans, and other components for controlling the environment within the passenger cabin by way of comp.

In one form, the vehicle control system 210 includes a navigation module 220, an HMI module 222, an object detection module 224, a drive control module 226, and a memory 228 for storing a map repository 230 and an object identification (ID) repository 232. The vehicle control system 210 may include one or more controllers that are configured as the modules 220, 222, 224, and 226. The one or more controllers may include a microprocessor, a memory for storing code executed by the processor circuit, and other suitable hardware components to provide the described functionality of the modules 220, 222, 224, and 226. While specific modules are illustrated, the vehicle control system 210 may include other modules for controlling components within the vehicle 300 such as a clime control module for controlling the climate control system and should not be limited to the modules described herein.

The navigation module 220 is configured to determine travel routes to a destination that is provided by the passenger by way of the HMI 206 based on a current location of the subject vehicle 100 and maps provided in the map repository 230. In one form, the map repository 230 stores various navigational maps that illustrate roads, traffic intersections, transit routes, points of interest, and other suitable information. The map repository 230 may also store characteristics of the road, such as intersection layout, traffic direction (e.g., one-way travel, or two-way), number of lanes along the road, and/or other suitable information.

The HMI module 222 is configured to operate the devices of the HMI 206 to provide information to and acquire commands from passengers of the vehicle 100. For example, the HMI module 222 controls the monitor 206-2 to display information regarding destination (e.g., address, names), the travel route, and a vehicle speed, among other information. Some of the information displayed may be provided by other modules within the vehicle control system 210 such as the navigation module 220 and drive control module 226. In another example, the HMI module 222 acquires the drive setting(s) such as a desired speed and activation/deactivation of the ACC application 110 by way of an ACC input 234, and provides the drive settings to requisite module such as the navigation module 220 and drive control module 226. The ACC input 234 may be a dedicated button on the steering wheel assembly, an icon on a touchscreen, or other suitable interface.

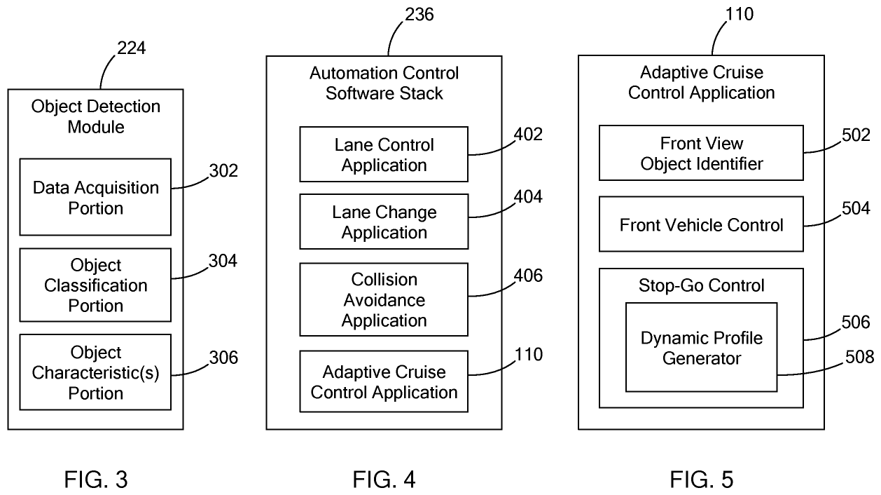

The object detection module 224 is configured to detect and identify (i.e., classify) objects about the subject vehicle 100 based on data from the object detectors 208 and the object ID repository 232. Referring to FIG. 3, in one form, the object detection module 224 is configured to have a data acquisition portion 302, an object classification portion 304, and an object characteristic(s) portion 306. The data acquisition portion 302 acquires data such as images from the camera(s) 208-3, signal data from LIDAR(s) 208-1 and/or radar(s) 208-2.

The object classification portion 304 is configured to detect and classify any detected objects based on the data acquired and the object ID repository. For example, in one form, using known object recognition software, the object classification portion 304 is configured to detect objects in the image(s) from the camera(s) 208-3 and then identify, or in other words, classify the detected objects using the data stored in the object identification repository 232. Specifically, the object identification repository 232 includes a library of preidentified objects that are assigned a classification, such as vehicles, pedestrians, stop signs, traffic light, buildings, etc. The object classification portion 304 is configured to compare the preidentified objects with those in the images acquired by the data acquisition portion 302 and assign a classification to the object such as a vehicle, a shrub (tree, bush, etc.), a signage, pedestrian, etc. In one form, the classification is predefined and if an object cannot be identified, it is classified as an unidentifiable object.

The object characteristic(s) portion 306 is configured to determine additional characteristics such as, but not limited to, position, distance, and/or speed of the classified object. For example, one or more of the object detectors 208 may emit a signal having predefined properties (e.g., frequency, waveform, amplitude, etc.), and receive a signal that is reflected off an object, such as an adjacent vehicle. The object characteristic(s) portion 306 is configured to analyze the signals transmitted and received to determine the characteristics provided above.

The object detection module 224 may also identify objects about the subject vehicle 100 based on messages from external devices via the V2X communication network. For example, other vehicles coupled to the communication network may transmit basic safety messages that provide a vehicle ID, speed, travel direction, and/or position to notify other devices of its presence. Using data from various sources, the objection detection module 224 is configured to identify objects and determine characteristics of the objects.

The drive control module 226 is configured to control various vehicle subsystems to drive the subject vehicle 100. In one form, the drive control module 226 receives data from various sensors regarding an input from a driver such as rotation of a steering wheel detected by an steering angle sensor, actuation of the acceleration pedal detected by an accelerator pedal sensor, and/or actuation of a brake pedal detected by a brake pedal position sensor. Based on these inputs and prestored control programs, the vehicle control module 226 transmits control signals to, for example, the drive system 218 to generate power via the engine or battery to move the vehicle 100 and/or to the brake system 216 to have the brakes reduce the speed of the vehicle 100. The drive control module 226 may output other control signals to control the drive operation of the subject vehicle 100 such as a control signal to the drive system 214 for accelerating the vehicle at an uniform or dynamic acceleration rate, and should not be limited to the examples provided herein.

Based on the level of automation, the drive control module 226 includes different software applications for performing automated drive control. In one form, the drive control module 226 is configured to include an automation control software stack 236 that provides control commands to the vehicle subsystems to autonomously control the subject vehicle 100. Referring to FIG. 4, in one form, the automation control software stack 236 includes a lane control application 402, a lane change application 404, a collision avoidance application 406, and the adaptive cruise control (ACC) application 110. The lane control application 402 is configured to maintain the subject vehicle 100 in the drive lane to inhibit the subject vehicle 100 from drifting to, for example, another drive lane. The lane change application 404 is configured to move the subject vehicle 100 from a first drive lane to a second drive lane. The collision avoidance application 406 is configured to inhibit collision and/or reduce collision impact with an object. It should be readily understood, that the automation control software stack 236 is not required to have the lane control application 402, the lane change application 404, and the collision avoidance application 406 in order to execute the ACC application 110, and that the automation control software stack 236 may include other software applications such as self-park application.

In one form, the ACC application 110 of the present disclosure is configured to determine whether a front vehicle and/or a stop-go object is provided in front of the subject vehicle 100 based on the identified objects from the object detection module. More particularly, in FIG. 1, a front direction of the subject vehicle 100 is generally identified by arrow A, and one or more of the object detectors 208 (not shown in FIG. 1) are arranged to detect objects provided in a front detection area (e.g., area B in FIG. 1). In one form, the front detection area is defined based on the detection range of the object detectors 208. In this example, the vehicle 104-1 is provided as a front vehicle since the subject vehicle 100 is directly behind the vehicle 104-1. On the other hand, vehicles 104-2 and 1043, while are within the front detection area, are not identified as front vehicles since the subject vehicle 100 is not following them.

A stop-go object is provided as an object that causes the subject vehicle 100 to come to a complete stop and/or yield and then begins to travel, and may include but should not be limited to: stop signs, yield signs, traffic lights, and/or moving objects such as pedestrians, cyclist, among others. In one form, the ACC application 110 includes a predefined list of objects that are considered stop-go objects.

The ACC application 110 is further configured to automatically control the speed of the subject vehicle 100 when a front vehicle is detected or provide a controlled deceleration and acceleration of the subject vehicle 100 when a stop-go object is detected. More particularly, in the event a front vehicle is detected, the ACC application 110 is configured to control the speed of the subject vehicle 100 based on characteristics of the front vehicle such as, but not limited to, position, distance, speed, deceleration, and/or acceleration (i.e., drive characteristics of the front vehicle). On the other hand, if a stop-go object is present, the ACC application 110 is configured to control one or more of the sub-systems in accordance with a dynamic profile that has a varying deceleration to bring the vehicle to a rest speed (e.g., 0 mph for stop signs and red traffic lights) and varying acceleration to increase the speed of the vehicle to a desired speed that may be defined by the driver or predetermined based on the speed limit of the road upon which the vehicle is driving.

Referring to FIG. 5, in one form, the ACC application 110 includes a front view object identifier 502, a front vehicle control 504, and a stop-go control 506. In one form, the front view object identifier 502 is configured to determine whether an identified object provided in the front detection area of the subject vehicle 100 is a front vehicle and/or a stop-go object based on a classification of the identified object. For example, based on the position of the identified object, the front view object identifier 502 acquires data regarding identified objects provided within the front detection area. The data acquired includes information regarding a classification of the identified object and/or characteristics of the identified object. For each identified object in the front detection area, the front view object identifier 502 determines if the identified object is a front vehicle or a stop-go object. In one form, the front view object identifier 502 may determine that an object classified as a vehicle is a front vehicle based on the drive characteristics of the vehicle, which provides the position and distance of the vehicle.

In another form, in addition to the identified object from the object detection module 224, the front view object identifier 502 is configured to determine whether a stop-go object is present based on the current location of the subject vehicle 100 and the maps in the map repository 230. That is, the maps provide detail information regarding the road upon which the subject vehicle is traveling such as presence of traffic signals and/or signage at intersections. Using the current location and travel direction of the vehicle 100, the front view object identifier 502 identifies potential stop-go objects.

If a front vehicle is present, the front vehicle control 504 is performed to control the speed of the subject vehicle 100 in accordance with a recommended speed that is determined based on drive characteristics of the front vehicle. In one form, the recommended speed is provided to have the subject vehicle 100 follow the front vehicle with a safety gap provided between. In one form, the safety gap is adjustable based on the travel speed, acceleration, and/or deceleration of the front vehicle such that if the front vehicle is decelerating the safety gap may be less than when the front vehicle is travelling at a constant speed.

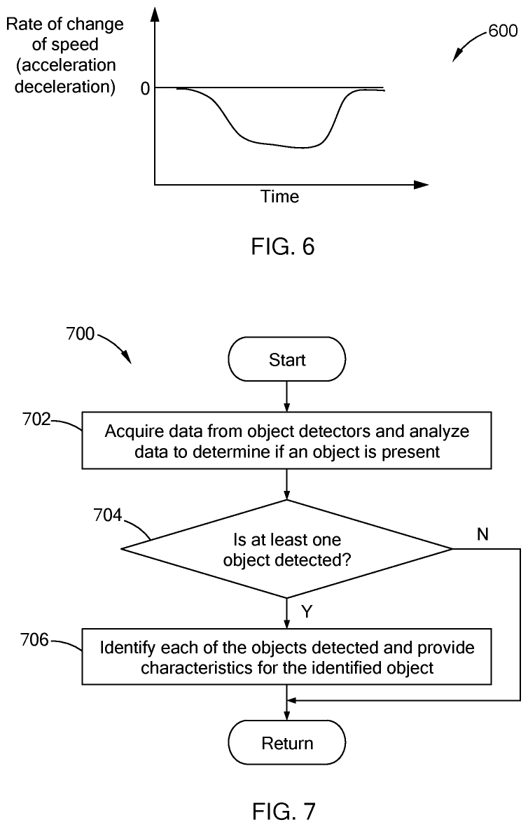

If a stop-go object is present, the stop-go control 506 is performed to decelerate and then accelerate the subject vehicle 100 in accordance with a dynamic profile. More particularly, in one form, the stop-go control 506 includes a dynamic profile generator 508 that generates a dynamic profile that defines the deceleration and acceleration of the subject vehicle 100 for the stop-go event. In one form, the dynamic profile generator 508 has one or more prestored profiles that provides predefined deceleration and acceleration rates. A dynamic profile is selected from among the prestored profiles based on the speed of the subject vehicle 100, the distance to the stop-go object, preference set by the driver using HMI, time of collision, and/or other suitable parameters such a governmental regulations. For example, FIG. 6 illustrates an example of a dynamic profile 600 that provides a deceleration rate and acceleration rate of the subject vehicle 100. In another form, the dynamic profile generator 508 may be a series of algorithms that define a dynamic profile based on a distance of the subject vehicle 100 from the stop-go object, the speed of the subject vehicle 100, and other driving conditions, like the curvature of the road. In yet another form, the dynamic profile generator 408 may include a machine learning model that is configured to learn dynamic profiles based on a driver's tendency when the ACC control is not activated. Based on the dynamic profile and the stop-go object, the stop-go control provides control signals to the vehicle subsystems to automatically stop/yield the subject vehicle and then accelerate the vehicle to the desired vehicle speed.

In one form, the stop-go control is further configured to control application of the dynamic profile based on the type of stop-go object detected. For example, if the stop-go object is a stop sign, the stop-go control waits until traffic has cleared before accelerating the subject vehicle 100. In another example, if the stop-go object is a traffic light, the stop-go control determines if the traffic light is red, and if it is the stop-go control decelerates the subject vehicle 100 in accordance with the dynamic profile and then waits until the traffic light is green before accelerating the subject vehicle 100. Otherwise, the stop-go control maintains the speed of the subject vehicle 100 to have the subject vehicle 100 travel through the green light.

In the event the front view object identifier 502 detects both a front vehicle and stop-go object, in one form, the ACC application 110 performs the control for the object closest to the subject vehicle 100. That is, if the front vehicle is closer, the front vehicle control 504 is performed first until the stop-go object is closer. For example, in FIG. 1, the front vehicle control 504 is performed until the front vehicle 104-1 passes the stop sign 106-1 and then the stop-go control 506 is performed to comply with the stop-go event provided by the stop sign 106-1.

In one form, the ACC application 110 is configured to perform the front vehicle control 504 when the subject vehicle is traveling along a highway or a road with minimal traffic controlled intersections. For example, the ACC application 110 may monitor the speed of the subject vehicle 100 and perform the front vehicle control when a front vehicle is present and the speed is greater than or equal to a cruise setpoint (e.g., 50 MPH+).

Referring to FIG. 7, an example object detection routine 700 performed by the object detection module is provided. The routine is performed when power is provided to the vehicle control system. At 702, the object detection module acquires data from front view object detectors and analyzes the data to determine if an object is present. For example, images from a camera disposed along a front portion of the vehicle is analyzed using the object ID repository to determine if an object provided from the repository is illustrated in the image from the camera. At 704, the object detection module determines if at least one object is detected, if not the module returns to the beginning of the routine 700. If at least one object is detected, the object detection module identifies or classifies each of the objects and provides characteristics for each identified object, at 706. In one form, the object detection module continues the routine until power is turned off to the vehicle control system. In one form, data regarding the identified object, which includes the characteristics, can be saved by the object detection module until power is turned off.

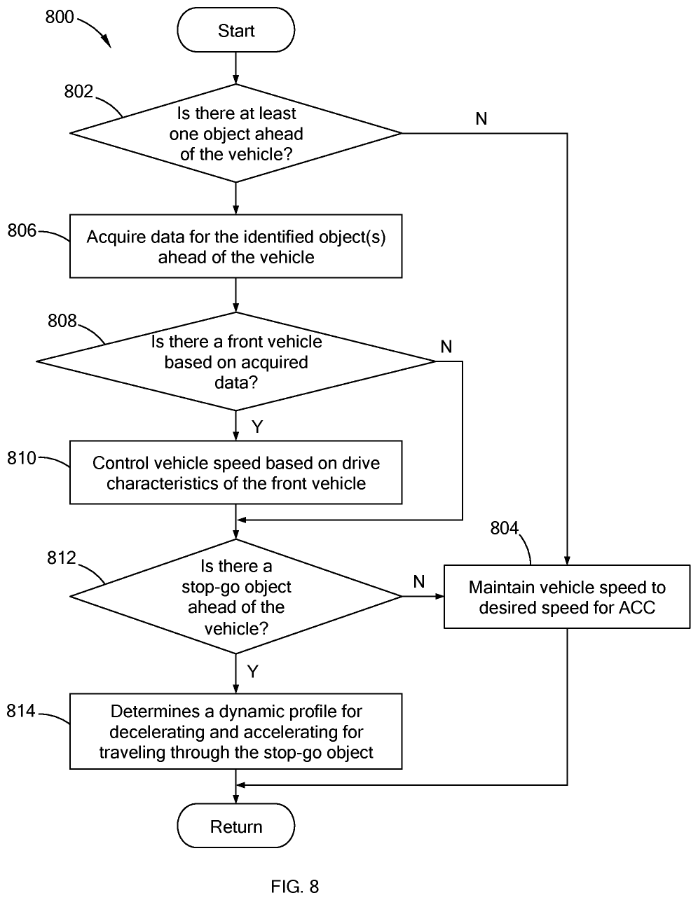

Referring to FIG. 8, an example ACC routine 800 performed by the drive control module is provided. In one form, the ACC routine 800 is performed when the ACC feature is activated by the driver. At 802, the drive control module determines if that is at least one object is ahead of the vehicle. For example, the driver control module may obtain information regarding possible identified objects provided in a front detection area of the subject vehicle from the objection detection module. If there is no object, the drive control module maintains the speed of the vehicle to a desired speed, at 804. If there is at least one object, the drive control module acquires data for the identified object(s) such as the classification and characteristics of the object, at 806. The drive control module then determines if there is a front vehicle based on the data acquired, at 808. If there is no a front vehicle, the drive control module moves to 812. If there is a front vehicle, the drive control module controls the speed of the subject vehicle based on drive characteristics of the front vehicle, at 810. More particularly, the drive control module determines a recommended speed for the subject vehicle based on the drive characteristics of the front vehicle and controls the speed of the subject vehicle based on the recommended speed. At 812, the drive control module determines if there is a stop-go object ahead of the subject vehicle. If there is no stop-go object, the drive control module maintains the vehicle speed to the desired speed, at 804. If there is a stop-go object, the drive control module determines a dynamic profile for decelerating and accelerating for traveling through the stop-go object.

The ACC application of the present disclosure provides an automated drive control for driving a vehicle through a stop-go event commonly found in urban areas. Specifically, the ACC application decelerates and accelerates the vehicle in accordance with a dynamic profile configured to provide smooth travel experience for the passenger(s) by reducing or inhibiting abrupt stops and acceleration. The ACC application further controls the speed of the vehicle based on a desired speed in the event not stop-go object is present. The desired speed can be set by the driver but can also be based on the drive characteristics of a present front vehicle.

Based on the foregoing, in one form, the present disclosure is directed towards a vehicle control system comprising a controller to be provided in a subject vehicle. The controller is configured to acquire data regarding an identified object ahead of the subject vehicle, where the data includes information indicative of a classification of the identified object. The controller is further configured to determine whether the identified object is a stop-go object based on the acquired data and output a stop-go control in response to the identified object being the stop-go object. The stop-go control generates a dynamic profile that defines a deceleration and an acceleration of the subject vehicle for automatically performing a stop-go operation.

In one form, the controller may further be configured to determine whether the identified object is a front vehicle based on the classification of the identified object and to output a recommended speed based on a drive characteristic of the front vehicle. According to this form, the drive characteristics of the front vehicle may include a speed of the front vehicle, an acceleration of the front vehicle, a position of the front vehicle, or a combination thereof.

In another form, the dynamic profile is defined to decelerate a speed of the subject vehicle at a varying deceleration rate to a rest speed and to accelerate the speed of the subject vehicle at a varying acceleration rate to a desired speed.

In other forms, the stop-go object includes at least one of a stop sign, a traffic light, or a moving object, and/or the controller is configured to maintain a speed of the subject vehicle in response to the identified object not being the stop-go object.

In yet another form, the vehicle control system further comprises one or more sensors disposed about a front portion of the subject vehicle to detect an object in a front detection area of the subject vehicle and a memory configured to store an object identification repository that includes data regarding different known objects. In this form, the controller is configured to detect an object based on data from the one or more sensors and the object identification repository, and to select a classification for the detected object from among a plurality of classifications.

In another form, the vehicle control system further comprises a memory configured to store a map repository that includes a plurality of traffic maps. The controller is configured to determine whether a traffic control device is provided ahead of the subject vehicle based on a map of an area being travelled by the subject vehicle and the traffic control device is provided as the stop-go object.

In still another form, the dynamic profile is provided in accordance with one of the following: selected from among a plurality of prestored profiles, determined using predefined algorithms, or determined using machine learning algorithm.

In another form, the present disclosure is further directed towards a vehicle control system comprising a controller to be provided in a subject vehicle. The controller is configured to acquire data regarding an identified object ahead of the subject vehicle, where the data includes information indicative of a classification of the identified object. In this form, the controller is configured to determine whether the identified object is a stop-go object or a front vehicle object based on the acquired data, and perform a stop-go control in response to the identified object being the stop-go object and a front vehicle control in response to the identified object being the front vehicle. The stop-go control generates a dynamic profile that define a deceleration and an acceleration of the subject vehicle for automatically performing a stop-go operation. The front vehicle control determines a recommended speed for the subject vehicle based on a drive characteristic of the front vehicle.

In one form, the drive characteristics of the front vehicle may include a speed of the front vehicle, an acceleration of the front vehicle, a position of the front vehicle, or a combination thereof.

In another form, the dynamic profile is defined to decelerate the speed of the subject vehicle at a varying deceleration rate to a rest speed and to accelerate the speed of the subject vehicle at a varying acceleration rate to a desired speed. In this form, the controller is configured to maintain the speed of the subject vehicle in response to the identified object not being the stop-go object.

In yet another form, the vehicle control system further comprises one or more sensors disposed about a front portion of the subject vehicle to detect an object in a front detection area of the subject vehicle and a memory configured to store an object identification repository that includes data regarding different known objects. In this form, the controller is configured to detect an object based on data from the one or more sensors and the object identification repository, and to select a classification for the detected object from among a plurality of classifications.

In another form, the vehicle control system further comprises a memory configured to store a map repository that includes a plurality of traffic maps. The controller is configured to determine whether a traffic control device is provided ahead of the subject vehicle based on a map of an area being travelled by the subject vehicle and the traffic control device is provided as the stop-go object.

In still another form, the dynamic profile is provided in accordance with one of the following: selected from among a plurality of prestored profiles, determined using predefined algorithms, or determined using machine learning algorithm.

In yet another form, the present disclosure is further directed towards a method for performing an adaptive cruise control. The method comprises: acquiring data regarding an identified object ahead of a subject vehicle, where the data includes information indicative of a classification of the identified object; determining whether the identified object is a stop-go object or a front vehicle based on the acquired data; performing a stop-go control in response to the identified object being the stop-go object; performing a front vehicle control in response to the identified object being the front vehicle; and maintaining a speed of the subject vehicle at a desired speed in response to the identified object not being the stop-go object or the front vehicle, where the desired speed is selectable. The stop-go control generates a dynamic profile that defines a deceleration and an acceleration of the subject vehicle for automatically performing a stop-go operation. The front control determines a recommended speed for the subject vehicle based on a drive characteristic of the front vehicle.

In one form, the method further comprises detecting, by one or more sensors, an object in a front detection area of the subject vehicle and selecting a classification for the detected object based on data in an object identification repository.

In another form, the method further comprises determining whether a traffic control device is provided ahead of the subject vehicle based on a map of an area being travelled by the subject vehicle, where the map is selected from among a plurality of maps stored in a map repository, and the traffic control device is provided as the stop-go object.

In another form, the dynamic profile is provided in accordance with one of the following: selected from among a plurality of prestored profiles, determined using predefined algorithms, or determined using machine learning algorithm.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “module” and/or “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle control system comprising:
a controller to be provided in a subject vehicle, the controller configured to:
acquire data regarding an identified object ahead of the subject vehicle, wherein the data includes information indicative of a classification of the identified object;
determine whether the identified object is a stop-go object based on the acquired data; and
output a stop-go control in response to the identified object being the stop-go object, wherein the stop-go control generates a dynamic profile that defines a deceleration and an acceleration of the subject vehicle for automatically performing a stop-go operation.

2. The vehicle control system of claim 1, wherein the controller is further configured to determine whether the identified object is a front vehicle based on the classification of the identified object and to output a recommended speed based on a drive characteristic of the front vehicle.

3. The vehicle control system of claim 2, wherein the drive characteristics of the front vehicle includes a speed of the front vehicle, an acceleration of the front vehicle, a position of the front vehicle, or a combination thereof.

4. The vehicle control system of claim 1, wherein the dynamic profile is defined to decelerate a speed of the subject vehicle at a varying deceleration rate to a rest speed and to accelerate the speed of the subject vehicle at a varying acceleration rate to a desired speed.

5. The vehicle control system of claim 1, wherein the stop-go object includes at least one of a stop sign, a traffic light, or a moving object.

6. The vehicle control system of claim 1, wherein the controller is configured to maintain a speed of the subject vehicle in response to the identified object not being the stop-go object.

7. The vehicle control system of claim 1 further comprising:
one or more sensors disposed about a front portion of the subject vehicle to detect an object in a front detection area of the subject vehicle; and
a memory configured to store an object identification repository that includes data regarding different known objects, wherein
the controller is configured to detect an object based on data from the one or more sensors and the object identification repository, and to select a classification for the detected object from among a plurality of classifications.

8. The vehicle control system of claim 1 further comprising a memory configured to store a map repository that includes a plurality of traffic maps, wherein the controller is configured to determine whether a traffic control device is provided ahead of the subject vehicle based on a map of an area being travelled by the subject vehicle, wherein the traffic control device is provided as the stop-go object.

9. The vehicle control system of claim 1, wherein the dynamic profile is provided in accordance with one of the following: selected from among a plurality of prestored profiles, determined using predefined algorithms, or determined using machine learning algorithm.

10. A vehicle control system comprising:
a controller to be provided in a subject vehicle, the controller configured to:
acquire data regarding an identified object ahead of the subject vehicle, wherein the data includes information indicative of a classification of the identified object;
determine whether the identified object is a stop-go object or a front vehicle object based on the acquired data; and
perform a stop-go control in response to the identified object being the stop-go object and a front vehicle control in response to the identified object being the front vehicle,
wherein the stop-go control generates a dynamic profile that define a deceleration and an acceleration of the subject vehicle for automatically performing a stop-go operation, and
wherein the front vehicle control determines a recommended speed for the subject vehicle based on a drive characteristic of the front vehicle.

11. The vehicle control system of claim 10, wherein the drive characteristics of the front vehicle includes a speed of the front vehicle, an acceleration of the front vehicle, a position of the front vehicle, or a combination thereof.

12. The vehicle control system of claim 10, wherein the dynamic profile is defined to decelerate the speed of the subject vehicle at a varying deceleration rate to a rest speed and to accelerate the speed of the subject vehicle at a varying acceleration rate to a desired speed.

13. The vehicle control system of claim 12, wherein the controller is configured to maintain the speed of the subject vehicle in response to the identified object not being the stop-go object.

14. The vehicle control system of claim 10 further comprising:
one or more sensors disposed about a front portion of the subject vehicle to detect an object in a front detection area of the subject vehicle; and
a memory configured to store an object identification repository that includes data regarding different known objects, wherein
the controller is configured to detect an object based on data from the one or more sensors and the object identification repository, and to select a classification for the detected object from among a plurality of classifications.

15. The vehicle control system of claim 10 further comprising a memory configured to store a map repository that includes a plurality of traffic maps, wherein the controller is configured to determine whether a traffic control device is provided ahead of the subject vehicle based on a map of an area being travelled by the subject vehicle, wherein the traffic control device is provided as the stop-go object.

16. The vehicle control system of claim 10, wherein the dynamic profiles is provided in accordance with one of the following: selected from among a plurality of prestored profiles, determined using predefined algorithms, or determined using machine learning algorithm.

17. A method for performing an adaptive cruise control, wherein the method comprising:
acquiring data regarding an identified object ahead of a subject vehicle, wherein the data includes information indicative of a classification of the identified object;
determining whether the identified object is a stop-go object or a front vehicle based on the acquired data;
performing a stop-go control in response to the identified object being the stop-go object, wherein the stop-go control generates a dynamic profile that defines a deceleration and an acceleration of the subject vehicle for automatically performing a stop-go operation;
performing a front vehicle control in response to the identified object being the front vehicle, wherein the front control determines a recommended speed for the subject vehicle based on a drive characteristic of the front vehicle; and
maintaining a speed of the subject vehicle at a desired speed in response to the identified object not being the stop-go object or the front vehicle, wherein the desired speed is selectable.

18. The method of claim 17 further comprising:
detecting, by one or more sensors, an object in a front detection area of the subject vehicle; and
selecting a classification for the detected object based on data in an object identification repository.

19. The method of claim 17 further comprising determining whether a traffic control device is provided ahead of the subject vehicle based on a map of an area being travelled by the subject vehicle, wherein the map is selected from among a plurality of maps stored in a map repository, the traffic control device is provided as the stop-go object.

20. The method of claim 17, wherein the dynamic profile is provided in accordance with one of the following: selected from among a plurality of prestored profiles, determined using predefined algorithms, or determined using machine learning algorithm.
